(19) United States
(12) Patent Application Publication
(10) Pub. No.: US 2006/0180091 A1
(43) Pub. Date: Aug. 17, 2006

(54) Peanut hull gypsum product and method of making same

(76) Inventor: Rete R. Odom JR., Madison, GA (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/124,932

(22) Filed: May 9, 2005

Related U.S. Application Data
(60) Provisional application No. 60/653,824, filed on Feb. 17, 2005.

(51) Int. Cl. A01K 29/00

(52) U.S. Cl. 119/171

(57) ABSTRACT

A composition of matter including gypsum, peanut hulls, and a binder is provided. A method of making such a composition also is provided. The composition may be used for various purposes, for example, as a carrier for a chemical.

### CROSS-REFERENCE TO RELATED APPLICATION

This application claims the benefit of U.S. Provisional Application 60/653,824 filed Feb. 17, 2004, incorporated by reference herein in its entirety.

### BACKGROUND

Commercial peanut shelling operations create large quantities of peanut hulls. There are some situations where peanut hulls are sold on a limited basis as a by-product of the shelling operation rather than discarded or processed as waste. For example, peanut hulls have been used for litter, as filler in artificial fireplace logs, and as cattle feed roughage. These limited uses, however, place demand far below shell availability.

Peanut hulls have the potential for profitable commercial use in other applications. For example, the chemical inertness of peanut hulls renders them suitable as carriers for various chemicals, such as pesticides and fertilizers. Additionally, the high absorbent capacity renders them potentially suitable for use in a number of industrial processes.

### SUMMARY

According to one aspect of the present invention, a composition of matter includes gypsum, peanut hulls, and a binder. The composition may include (a) from about 45 to about 49 wt % gypsum, (b) from about 45 to about 49 wt % peanut hulls, and (c) from about 2 to about 10 wt % binder. Other compositions are disclosed herein or contemplated hereby. For example, the composition may include (a) substantially equal amounts of gypsum and peanut hulls, and (b) from about 2 to about 10 wt % binder. The binder may be a citrus-based binder, calcium lignosulfonate, or any combination thereof. The composition may be used to form a plurality of granules, which may have a bulk density of from about 35 to about 50 lb/ft³. The composition may be used, for example, as a carrier for a chemical, an absorbent material, or an agricultural product.

According to another aspect of the invention, a carrier for a chemical includes a granulated product of gypsum, peanut hulls, and a binder. The carrier may include (a) from about 45 to about 49 wt % gypsum, (b) from about 45 to about 49 wt % peanut hulls, and (c) from about 2 to about 10 wt % binder. The carrier may have a bulk density of from about 35 to about 50 lb/ft³.

According to yet another aspect of the present invention, an agricultural product includes an agricultural chemical supported on a carrier. The carrier includes gypsum, peanut hulls, and a binder. The agricultural chemical may be a pesticide, insecticide, herbicide, fungicide, rodenticide, nematicide, fertilizer, soil ameliorant, biocide, or any combination thereof.

The present invention also contemplates various methods of preparing such a composition or composite material. In one aspect, a method of making a composite material includes granulating a mixture of gypsum, peanut hulls, and a binder to form a granulated composite material. In another aspect, a method of making a carrier for a chemical includes combining gypsum, peanut hulls, and a binder to form a carrier composition, and granulating the carrier composition to form a carrier. The method further may include drying the carrier, screening the carrier, separating the carrier into undersized cuts, product cuts, and oversized cuts, or any combination thereof.

In another aspect, a method of making composite granules comprises granulating a mixture comprising gypsum, peanut hulls, binder, and water to form composite granules, drying the composite granules to a water content of from about 25 wt % to about 35 wt %, optionally screening the composite granules to achieve a desired granule size, and further drying the composite granules to a water content of less than about 1 wt %. The composite granule may be, for example, an absorbent granule or a carrier for a chemical.

In yet another aspect, a method of making an agricultural product includes preparing a granulated mixture of gypsum, peanut hulls, and a binder, contacting the granulated mixture with an agricultural chemical to form an agricultural product, and optionally drying the agricultural product. The agricultural chemical may be a pesticide, insecticide, herbicide, fungicide, rodenticide, nematicide, fertilizer, soil ameliorant, biocide, or any combination thereof.

These and other aspects are set forth in greater detail in the detailed description below and in the accompanying drawings.

### BRIEF DESCRIPTION OF THE DRAWING

FIG. 1 illustrates an exemplary process for forming a composite granulated product according to the present invention.

### DETAILED DESCRIPTION

In one aspect, the present invention relates to a composition of matter that may be used as a carrier for one or more chemicals, for example, an agricultural chemical. The composition may include a composite granulated material or product, for example, of ground peanut hulls, gypsum, and a binder. The composition may be used a carrier for one or more chemicals, for example, an agricultural chemical.

An agricultural product including an agricultural chemical and a carrier including gypsum, peanut hulls, and a binder also is provided. In such a product, the chemical is supported on or absorbed into (hereinafter “supported on”) the carrier. The chemical elutes from the carrier at a predetermined rate during use. Examples of agricultural chemicals include, but are not limited to, pesticides, insecticides, herbicides, fungicides, rodenticides, nematicides, fertilizers, soil ameliorants, biocides, or any combination thereof. The various compositions and composites contemplated hereby also may be used as an absorbent material in industrial processes, or for other purposes.

According to one aspect of the invention, a composition of matter includes gypsum, peanut hulls, and a binder. The peanut hulls may be crushed, may be fines, or may be a combination thereof. Thus, the peanut hulls may include from 0 to 100 wt % crushed hulls, 0 to 100 wt % crushed fines, or any combination thereof. In one aspect, the peanut hulls include from about 10 to about 20 wt % crushed hulls and about 20 to about 90 wt % fines. In another aspect, the peanut hulls include from about 20 to about 30 wt % crushed hulls and about 70 to about 80 wt % fines. In another aspect, the peanut hulls include from about 30 to about 40 wt % crushed hulls and about 60 to about 70 wt % fines. In yet another aspect, the peanut hulls include from about 40 to about 50 wt % crushed hulls and about 50 to about 60 wt % fines. In still another aspect, the peanut hulls include from about 50 to about 60 wt % crushed hulls and about 40 to about 50 wt % fines. In yet another aspect, the peanut hulls include from about 60 to about 70 wt % crushed hulls and about 30 to about 40 wt % fines. In still another aspect, the peanut hulls include from about 70 to about 80 wt % crushed hulls and about 20 to about 30 wt % fines. In yet another aspect, the peanut hulls include from about 80 to about 90 wt % crushed hulls and about 10 to about 20 wt % fines. Other minor components may be present.

The binder may be any suitable binder as desired, and in one aspect, may be a citrus-based binder, for example, a citrus residue binder, calcium lignosulfonate, or any combination thereof. One example of a citrus residue binder that may be suitable for use with various aspects of the present invention is Citrus Residuum, commercially available from Douglas Fertilizer Company. Citrus Residuum is derived from processed citrus pulp. The binder may be provided and/or applied as a dispersion having any solids level as desired, and may be concentrated or diluted as needed for a particular application. In one aspect, the binder has a solids content of from about 30 to about 40 wt %. In another aspect, the binder has a solids content of from about 40 to about 50 wt %. In another aspect, the binder has a solids content of from about 50 to about 60 wt %. In yet another aspect, the binder has a solids content of from about 60 to about 70 wt %. Thus, in one particular example, the binder may be a dispersion that includes about 58% calcium lignosulfonate. Other solids content levels are contemplated hereby.

The various components may be present in any suitable amount needed to achieve the desired characteristics. Thus, the relative amounts of the components and the process conditions may be varied to achieve a particular bulk density (and the desired “throw weight” for uniform product application), abrasion resistance (generally less than about 2% attrition), chemical release rate (where used as a carrier), or level of dust. In one aspect, the ratio of gypsum to peanut hulls is from about 30:70 to about 70:30. In another aspect, the ratio of gypsum to peanut hulls is from about 40:60 to about 60:40. In still another aspect, the ratio of gypsum to peanut hulls is from about 45:55 to about 55:45. In yet another aspect, the gypsum and peanut hulls are present in an about equal amounts, i.e., about 50:50.

The binder may be present in any suitable amount as needed to effectively bind the gypsum and peanut hulls. In one aspect, the binder is present in an amount of from about 2 to about 10 wt % of the composition. In another aspect, the binder is present in an amount of about 4 to about 8 wt % of the composition. In yet another aspect, the binder is present in an amount of about 7 wt % of the composition.

Thus, according to one aspect of the present invention, the composition includes from about 45 to about 49 wt % gypsum, from about 45 to about 49 wt % peanut hulls (crushed and fines), and from about 2 to about 10 wt % binder. According to another aspect, the composition includes substantially equal amounts of gypsum and peanut hulls, and from about 2 to about 10 wt % binder. According to yet another aspect, a composition includes from about 46 to about 48 wt % gypsum, from about 46 to about 48 wt % peanut hulls, and from about 4 to about 8 wt % binder. According to still another aspect, the composition includes from about 45 to about 46 wt % gypsum, from about 45 to about 46 wt % peanut hulls, and about 7 wt % binder.

The resulting composition or material may have a bulk density of from about 35 to about 50 lb/ft³. In one aspect, the material has a bulk density of from about 38 to about 48 lb/ft³. In another aspect, the material has a bulk density of about 40 lb/ft³.

The various compositions of matter contemplated by the present invention may be formed by any suitable process. In general, the components to be granulated are blended in a mixer, rounded in a drum, dried, and screened to achieve the desired weight, density, shape, size, moisture level, and structural integrity of the product. Such materials may be used for numerous purposes, for example as a carrier for a chemical or as a moisture absorbent material for use in industrial processes.

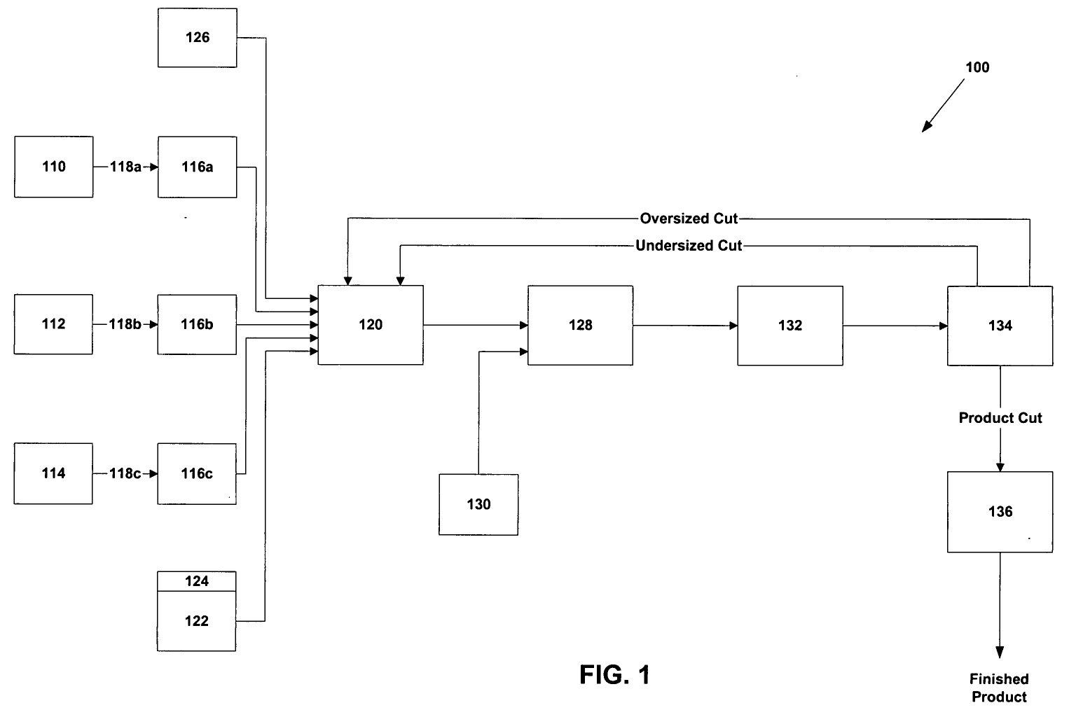

Turning to FIG. 1, an exemplary process 100 for forming a composite material according to the present invention is provided. It will be understood that although exemplary equipment, sizes, tolerances, and specifications are described herein, other equipment, sizes, tolerances, and specifications are contemplated hereby.

Crushed peanut hulls 110, fines 112, and gypsum 114 are delivered to one or more raw material hoppers 116a, 116b, 116c using one or more raw material elevators or conveyors 118a, 118b, 118c that provide gentle handling of the materials. Binder 122 is stored in a tank 124 or other suitable storage device. For example, the binder may be stored in a 24 in. diameter by 48 in. tall stainless steel tank equipped with four 2 in. wide by 24 in. long baffles evenly spaced around the inside circumference of the tank. A variable speed propeller style agitator may be provided to agitate the binder within tank. The tank may be equipped with a 1.5 in. diameter vented pick-up pipe located about 6 in. from the bottom of the tank. The pick-up may discharge a distance, for example, 24 in. from the bottom of the tank.

Crushed peanut hulls 110 are metered to a pugmill mixer 120 or other suitable mixing device using, for example, a volumetric feeder, for example, a KTRON Corp. Model F2 variable speed, stainless steel screw-metered volumetric feeder (not shown). Fines 112 are metered to the pugmill mixer 120 using, for example, a stainless steel volumetric belt feeder (not shown) having a 5 cubic foot feed hopper. Gypsum 114 is metered to the pugmill mixer 120 by, for example, a volumetric feeder, such as a KTRON Corp. Model F2 screw-metered volumetric feeder (not shown). A pump (not shown), such as a variable speed processing cavity pump, pumps the binder 122 to the pugmill mixer 120. The piping may be 0.5 in. stainless steel schedule 40 pipe with a recirculation loop. The flow rate may be monitored by maintaining weighed sample versus time. Water 126 is supplied to the pugmill mixer 120 by water lines with rotometers or other means to control the flow rate.

The pugmill mixer 120 may be a 3 cubic foot pugmill, with stainless steel contact parts, for example, 304 stainless steel. In one example, the pugmill mixer is equipped with two shafts with 15 counter-rotating blades per shaft. The blades may feature paddles positioned at an angle of about 45 degrees. A motor, such as a 5 hp motor, powers the pugmill mixer.

The blended materials are discharged from the pugmill mixer 120 and conveyed to a granulation drum 128. Water 130 is provided to the granulation drum 128 for use primarily during start-up. In one example, the granulation drum is positioned on a variable speed drum base (not shown), such as a carbon steel 6 ft drum base. A rotary drum, such as a 3 ft diameter carbon steel rotary drum with overall length of 6 ft, may be mounted on the base. The drum inlet ring generally may measure about 10 in. and the discharge ring generally may measure about 6 in. The discharge ring may be equipped with a cutout, for example, 6 in. long by 2 in. tall. The discharge ring may be mounted from the end board and from the discharge of the drum, forming a rollout section with without a retention ring. The granulation drum 128 is operated at a set revolution per minute (rpm) speed, for example, 11 rpm. In one example, the drum has no flights and is equipped with an oscillating scraper bar to prevent build-up on the drum shell. The discharge of the drum may be equipped with a combination fume hood and discharge chute. Ambient air may be pulled concurrently through the drum by a scrubber system. The drum may be insulated to prevent heat loss.

The material then is discharged from the drum 128 into a drying drum 132, where the material is dried to a water content of about 25 to about 35 wt %, for example 30 wt %. The drying drum may be, for example, a 3 ft diameter carbon steel rotary drum with a 6 ft length. The drying drum may be positioned on a variable speed drum base, such as a 6 ft carbon steel drum base. A drum inlet ring may measure 10 in. without a discharge ring. The drum may be equipped with three sets of 3 in. tall by 20 in. long flights with a 90-degree-1 inch lip. The drum 128 is operated at a set speed, for example, 10 rpm. The drum may include flight sets positioned in a staggered pattern on the inside circumference of the drum. The discharge of the drum may be equipped with a combination fume hood and discharge chute.

Air having a temperature of, for example, from about 700° F. to about 800° F. can be blown through the drum and exhausted to a scrubber (not shown). In one example, a radial blade blower may direct air into the inlet end of the drying drum through a duct with a diffuser plate at the outlet. A natural gas burner heats ambient air. The air temperature is controlled by a natural gas burner control system. The product discharge from the drying drum is also at a set temperature, for example, at from about 110° F. to about 120° F. If desired, the heat source could be fuel oil or other practical sources. The drum may be insulated to prevent heat loss.

The material then is transported to a screener 134 where the material is separated into oversized, product, and undersized cuts. The screener may include any suitable device, such as a Roball or Rotex screen. The screen sizes can be any size or stock, for example, 10 or 14 mesh US. The oversize and undersize cuts are transported back to the pugmill mixer 120 to be re-granulated with the incoming raw feed as recycle to control improperly sized granules from proceeding to final product. The recycle stream is metered into the granulation drum by a volumetric belt feeder, with the belt speed and gate height determining the feed rate. The feeder may be constructed of stainless steel with a three cubic foot feed hopper, with the belt speed being controlled by a variable speed controller.

If needed or desired, the product may be batch dried, for example, in one or more fluidized bed dryers 136, before final packaging in 55 gal drums or otherwise. For example, the dryer may include a static bed constructed of 304 stainless steel with a 5 sq. ft. screen area and bed depth of about 10 in. The screen may measure about 15 in. wide by about 48 in. long and can be constructed, for example, of stainless steel with a specified open area, for example, about 6.33%. A NYB Series 20 GI Fan, size 264 blower with a 15 hp motor may be used as the fluidization blower. Heat may be provided by a natural gas burner control package at a specified rate, such as at 10 million BTU. The dried composite material is removed at the completion of each run.

If desired, dust from the fluidized bed can be collected in a carbon steel baghouse dust collection system (not shown). The baghouse may be constructed of painted carbon steel, may be 85 in. tall by 34 in. wide with a cone bottom, and may be equipped with sixteen 6 in. diameter by 72 in. long polyester bags rated for 5 micron that are back-pulsed at 25-second intervals with 125 psi air. The exhaust blower may be a Dayton Model 3C54D 0.125 in. blower with a 10 hp motor that exhausts to the atmosphere. At the completion of each run, the fines may be emptied through a slide gate at the cone.

In one aspect, for example, where a 50:50 mixture of crushed peanut hull and gypsum is used, a bed temperature of from about 85° F. to about 88° F. may be used. A recycle temperature of from about 85° F. to about 88° F. may be used. A dryer discharge temperature of from about 108° F. to about 112° F. may be used. A dryer inlet air temperature of from about 700° F. to about 800° F. may be used. In this aspect, the water content of the material at the pugmill mixer discharge may be from about 40 to about 45 wt %. The water content at the granulation drum discharge may be from about 40 to about 45 wt %. The water content at the dryer drum discharge may be from about 25 to about 30 wt %. The water content of the final product typically is less than 1 wt %.

The granulated composite may be used for numerous purposes described herein or contemplated hereby. In one aspect, the granulated composite is used as an absorbent material. In another aspect, the granulated composite is used as a carrier for one or more chemical. In such an aspect, the carrier is contacted with the chemical to be supported on the carrier. If needed or desired, the carrier with the chemical may be dried to achieve a particular water content.

While the invention has been described in preferred terms, variations can be made without deviating from the invention. For example, a fluid bed dryer can replace the rotary dryer to allow more efficient drying and to remove long fibers found in the ground hulls. Further, a second fluid bed dryer can be used for final drying of the product. Examples of other granulation processes that may be suitable for use with the present invention include, but are not limited to, those described in U.S. Pat. Nos. 5,041,410 and 5,219,818, both of which are incorporated by reference herein in their entirety.

Accordingly, it will be readily understood by those persons skilled in the art that, in view of the above detailed description of the invention, the present invention is susceptible of broad utility and application. Many adaptations of the present invention other than those herein described, as well as many variations, modifications, and equivalent arrangements will be apparent from or reasonably suggested by the present invention and the above detailed description thereof, without departing from the substance or scope of the invention.

While the present invention is described herein in detail in relation to specific aspects, it is to be understood that this detailed description is only illustrative and exemplary of the present invention and is made merely for purposes of providing a full and enabling disclosure of the present invention. The detailed description set forth herein is not intended nor is to be construed to limit the present invention or otherwise to exclude any such other embodiments, adaptations, variations, modifications, and equivalent arrangements of the present invention, the present invention being limited solely by the claims appended hereto and the equivalents thereof.

What is claimed is:

1. A method of making a composite material comprising:
granulating a mixture of gypsum, peanut hulls, and a binder to form a granulated composite material.

2. The method of claim 1, wherein the granulated composite material comprises:
(a) from about 45 to about 49 wt % gypsum;
(b) from about 45 to about 49 wt % peanut hulls; and
(c) from about 2 to about 10 wt % binder.

3. The method of claim 1, wherein the granulated composite material comprises:
(a) substantially equal amounts of gypsum and peanut hulls; and
(b) from about 2 to about 10 wt % binder.

4. The method of claim 1, wherein the granulated composite material comprises:
(a) from about 46 to about 48 wt % gypsum;
(b) from about 46 to about 48 wt % peanut hulls; and
(c) from about 4 to about 8 wt % binder.

5. The method of claim 1, wherein the granulated composite material comprises:
(a) from about 45 to about 46 wt % gypsum;
(b) from about 45 to about 46 wt % peanut hulls; and
(c) about 7 wt % binder.

6. The method of claim 1, wherein the binder is a citrus-based binder, calcium lignosulfonate, or any combination thereof.

7. A method of making a carrier for a chemical comprising:
combining gypsum, peanut hulls, and a binder to form a carrier composition; and
granulating the carrier composition to form a carrier.

8. The method of claim 7, further comprising:
(a) drying the carrier;
(b) screening the carrier;
(c) separating the carrier into undersized cuts, product cuts, and oversized cuts; or
(d) any combination thereof.

9. The method of claim 7, wherein the carrier comprises:
(a) from about 45 to about 49 wt % gypsum;
(b) from about 45 to about 49 wt % peanut hulls; and
(c) from about 2 to about 10 wt % binder.

10. The method of claim 7, wherein the binder is a citrus-based binder, calcium lignosulfonate, or any combination thereof.

11. A method of making composite granules comprising:
(a) granulating a mixture comprising gypsum, peanut hulls, binder, and water to form composite granules;
(b) drying the composite granules to a water content of from about 25 wt % to about 35 wt %;
(c) optionally, screening the composite granules to achieve a desired granule size; and
(d) further drying the composite granules to a water content of less than about 1 wt %.

12. The method of claim 11, wherein the composite granules comprise:
(a) from about 45 to about 49 wt % gypsum;
(b) from about 45 to about 49 wt % peanut hulls; and
(c) from about 2 to about 10 wt % binder.

13. The method of claim 11, wherein the composite granule is an absorbent granule.

14. The method of claim 11, wherein the composite granule is a carrier for a chemical.

15. A method of making an agricultural product comprising:
(a) preparing a granulated mixture of gypsum, peanut hulls, and a binder;
(b) contacting the granulated mixture with an agricultural chemical to form an agricultural product; and
(c) optionally, drying the agricultural product.

16. The method of claim 15, wherein the granulated mixture comprises:
(a) from about 45 to about 49 wt % gypsum;
(b) from about 45 to about 49 wt % peanut hulls; and
(c) from about 2 to about 10 wt % binder.

17. The method of claim 15, wherein the granulated mixture comprises:
(a) substantially equal amounts of gypsum and peanut hulls; and
(b) from about 2 to about 10 wt % binder.

18. The method of claim 15, wherein the granulated mixture comprises:
(a) from about 46 to about 48 wt % gypsum;
(b) from about 46 to about 48 wt % peanut hulls; and
(c) from about 4 to about 8 wt % binder.

19. The method of claim 15, wherein the binder is a citrus-based binder, calcium lignosulfonate, or any combination thereof.

20. The method of claim 15, wherein the agricultural chemical is a pesticide, insecticide, herbicide, fungicide, rodenticide, nematicide, fertilizer, soil ameliorant, biocide, or any combination thereof.
